(19) United States
(12) Patent Application Publication
(10) Pub. No.: US 2022/0163341 A1
(43) Pub. Date: May 26, 2022

(54) NAVIGATION SYSTEM

(71) Applicant: Faurecia Clarion Electronics Co., Ltd., Saitama-shi, Saitama (JP)

(72) Inventors: Mitsunori MARU, Tokyo (JP); Isamu ODA, Saitama (JP); Hiroyuki SATO, Saitama (JP); Takaaki SHIINA, Saitama (JP); Takashi MATSUMOTO, Tokyo (JP)

(73) Assignee: Faurecia Clarion Electronics Co., Ltd., Saitama-shi, Saitama (JP)

(21) Appl. No.: 17/441,608

(22) PCT Filed: Mar. 19, 2020
(86) PCT No.: PCT/JP2020/012478

§ 371 Date: Sep. 21, 2021

(30) Foreign Application Priority Data
Mar. 22, 2019 (JP) 2019-054041

(51) Int. Cl. G01C 21/36

(52) U.S. Cl. CPC G01C 21/3658

(57) ABSTRACT

A user is notified of a recommendation lane as appropriate. A navigation system includes one or more processors, and one or more storage devices storing programs to be executed by the one or more processors. The one or more processors decide a lane change plan creation zone including a main lane group including a plurality of main lanes that is parallel to each other in a route between a place of departure and a destination, and a recommendation degree of each of a plurality of lane links included in the main lane group. The one or more processors generate a lane change plan on the basis of the lane change plan creation zone and the recommendation degree.

### FIELD OF INVENTION

The present invention relates to a navigation system. This application claims the priority based on the Japanese Patent Application No. 2019-54041 filed on Mar. 22, 2019. The entire contents of which are incorporated herein by reference for all purpose.

### TECHNICAL BACKGROUND

One example of the background techniques of the present disclosure is JP 2017-53678 A. JP 2017-53678 A discloses a travel support system capable of guiding in an intuitively comprehensible mode in a guidance for a vehicle travel. More specifically, the disclosure discloses that the travel support system is configured to: specify a traffic lane to guide a vehicle; specify a traffic lane change recommendation zone for recommending a driver to change the traffic lane to a guide traffic lane; display an image of a road on which the vehicle travels on an HUD 19; and display a plurality of instruction images 65 for prompting the driver to change the traffic lane by superimposing on the traffic lane change recommendation zone in the displayed road image (Abstract).

### CITATION LIST

### Patent Literature

Patent Literature 1: JP 2017-53678 A

### SUMMARY

### Technical Problem

Selecting and changing to the suitable travel lane are difficult tasks for a driver and an automated driving system. For example, in the travel on a path where a road merges with a main lane from a left side and then a road branches to a right side, it is difficult for the driver to decide which lane he should travel after merging (select lane) and for example, he needs to consider how the lane will change (the number of lanes will decrease or increase) ahead. In view of the above, it would be very helpful for the user in a lane change plan if a navigation system created the lane change plan and the user could know the recommendation lane according to the lane change plan while the driver or the automated driving system drives.

### Solution to Problem

One aspect of the present disclosure is a navigation system for a vehicle, the navigation system including: one or more processors; and one or more storage devices storing programs to be executed by the one or more processors, in which the one or more processors decide a lane change plan creation zone including a main lane group including a plurality of main lanes that is parallel to each other in a route between a place of departure and a destination, and a recommendation degree of each of a plurality of lane links in the main lane group, and the one or more processors generate a lane change plan on the basis of the lane change plan creation zone and the recommendation degree.

### Advantageous Effects of Invention

According to the aspect of the present invention, the user can be notified of the recommendation lane as appropriate.

### BRIEF DESCRIPTION OF THE DRAWINGS

FIG. 1 illustrates an example of a display image that a navigation system provides to a user.

FIG. 2 schematically illustrates a lane change plan creation zone and lane links forming each lane in an area illustrated in FIG. 1.

FIG. 3 schematically illustrates an example of how to decide the lane change plan creation zone.

FIG. 4 illustrates an example of a condition for a lane change plan creation zone end position.

FIG. 5 illustrates an example of a condition for a lane change plan creation zone start position.

FIG. 6 illustrates an example of a condition for the lane change plan creation zone start position.

FIG. 7 illustrates an example of a condition for the lane change plan creation zone start position.

FIG. 8 is a diagram for describing a variable that is referred to in the calculation of a recommendation degree.

FIG. 9 is a diagram for describing another example of the variable that is referred in the calculation of the recommendation degree.

FIG. 10 illustrates a display image by a navigation system that is used in FIG. 9.

FIG. 11 is a flowchart of an example of calculating the recommendation degree.

FIG. 12 illustrates a lane change start recommendation zone in the lane change.

FIG. 13 illustrates an image example 10 that illustrates the distance to the nearest indispensable lane change as a reason of the lane recommendation degree.

FIG. 14 illustrates an image example that illustrates lane level traffic congestion information.

FIG. 15 illustrates a display image example that illustrates a lane change prohibition zone as a reason of a lane change recommendation position.

FIG. 16 illustrates a display image example that illustrates a tunnel as a reason of the lane change recommendation position.

FIG. 17 schematically illustrates a structure example of a navigation device disposed in a vehicle as an example of the navigation system.

FIG. 18 illustrates a structure example of a route guidance information distribution server including a part of navigation functions according to the present disclosure.

FIG. 19 illustrates a structure example of a lane change plan table.

FIG. 20 illustrates an example of a flow chart for procedure of an overall process for providing navigation information according to the present embodiment.

FIG. 21 is a flowchart illustrating an example of creating the lane change plan table.

FIG. 22 is a flowchart illustrating an example of a process in which lane link information is input to the lane change plan table about one lane link.

### DETAILED DESCRIPTION

One embodiment of the present invention is hereinafter described with reference to drawings. In each drawing, the members or elements with the same operation or function are denoted by the same reference sign and the same description is omitted.

The route information that is provided to a driver and/or an automated driving system by a navigation system for a vehicle has been required to have higher quality (safety, accuracy, etc.). Selecting and changing the travel lane are difficult tasks for the driver and the automated driving system, and a suitable lane change plan and the provision of such a lane change plan to the driver have been required.

While the driver himself drives or during the automated driving, the information about the lane change plan is important information for the user who sees the navigation system including the driver. The navigation system disclosed below creates the lane change plan and provides a recommendation lane among a plurality of lanes to the user. For example, the navigation system provides the recommendation degrees for the respective lanes. The recommendation degree can be expressed by a color, a pattern, blinking, a numeral, or the like.

For example, the navigation system provides the recommendation position for the lane change in addition to the information about the recommendation lane. Thus, the difficulty and the number of times of determining the lane selection/change can be reduced as appropriate.

In one example, the overall image in lane selection/change in the route from the current position of the vehicle to the final branch is guided so that the user can understand the lane change plan to the final branch. Thus, the user can know the reason why this recommendation lane is recommended or the reason why this recommendation position for the lane change is recommended. Furthermore, explicitly showing the reason why the recommendation lane and/or the lane change recommendation position is decided can help the user's understanding.

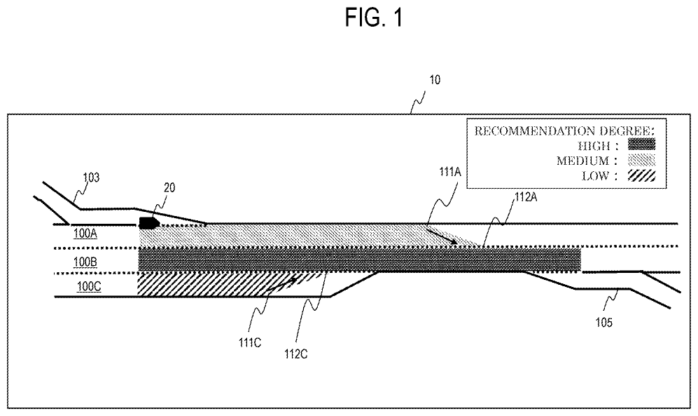

FIG. 1 illustrates an example 10 of a display image (lane change plan image) that the navigation system provides to the user. In the display image example in FIG. 1, the vehicle travels in a lateral direction (left to right). In another example, the vehicle may travel in another lateral direction (right to left) or in a vertical direction (from above to below, or from below to above). A vehicle image 20 expresses the current vehicle position and is on a merge lane 103 that merges with a main lane group including main lanes 100A, 100B, and 100C. The route of the vehicle continues to a branch lane 105 that branches from the main lane group. That is to say, the vehicle is scheduled to enter the branch lane 105 from the main lane 100C.

The display image 10 displays the lane change plan in one lane change plan creation zone to be described below (also referred to as plan creation zone simply). Specifically, the display image 10 shows the recommendation degree at each position (position on the route) in each of the main lanes 100A, 100B, and 100C that are parallel to each other with the patterns. In the example in FIG. 1, the recommendation degree of the main lane 100B is the highest and the recommendation degree of the main lane 100C is the lowest, and the recommendation degree of the main lane 100A is between them. The display image 10 expresses the recommendation degree of each of the main lanes in the zone from the merge position of the merge lane 103 to the branch position of the branch lane 105.

The display image 10 shows a lane change start recommendation zone with the tilts (oblique sides) of the pattern. In the example in FIG. 1, a position 111C expresses a start position of the lane change start recommendation zone from the lane 100C to the lane 100B. A position 112C expresses an end position of the lane change start recommendation zone from the lane 100C to the lane 100B. The vehicle is recommended to start to change lanes between the position 111C and the position 112C. Similarly, the vehicle is recommended to start to change lanes from the lane 100A to the lane 100B between the position 111A and the position 112A.

When the current vehicle position has reach the position 111C or 111A, the navigation system may provide the information with a sound and/or an image to prompt the lane change. When the current vehicle position has become the position 111C in the lane 100C, for example, the navigation system outputs the sound and/or the image to prompt the lane change from the lane 100C to the lane 100A. When the current vehicle position has reach the position 111A in the lane 100A, for example, the navigation system outputs the sound and/or the image to prompt the lane change from the lane 100A to the lane 100B.

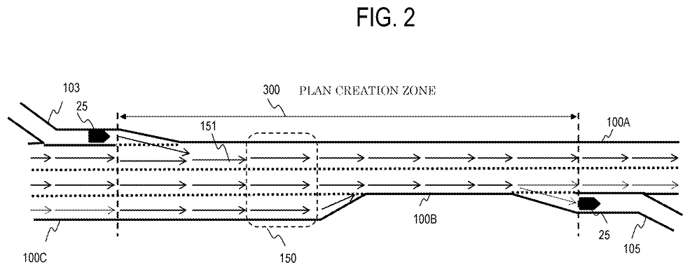

FIG. 2 schematically illustrates the plan creation zone and lane links forming each lane in the area illustrated in FIG. 1. The lane links are registered in advance in the map information. In the example in FIG. 2, a plan creation zone 300 ranges from a merge position between the merge lane 103 and the main lane 100A to a branch position where the branch lane 105 branches from the main lane 100C. As illustrated in FIG. 2, a vehicle 25 joins the main lane 100A from the merge lane 103, travels in the lane selected from the main lane group 100A, 100B, and 100C and goes to the branch lane 105 from the main lane 100C.

An arrow 151 in each lane (one arrow is denoted by a reference sign 151 as one example) expresses the lane link. The lane link 151 is a part of the lane and the arrow represents the travel direction and the area of the lane link. The start position and the end position of each lane link 151 are defined by the position on the route. Each lane link 151 in each of the lanes at the same positions on the route represents the area between the same positions on the route. The lane links 151 at the same position on the route form a lane link group 150.

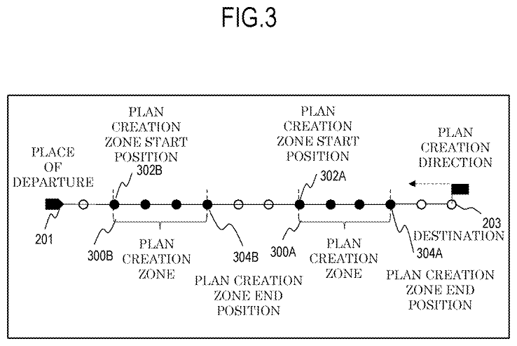

Next, a method for creating the lane change plan in the plan creation zone is schematically described. FIG. 3 schematically illustrates an example of how to decide the plan creation zone. The navigation system searches for the plan creation zone (zone where the lane selection or change occurs), going back the route of the vehicle from a destination 203 to a place of departure 201. Each part of the route is expressed by one road, and one road is formed by one or a plurality of lanes. The road is formed by continuous road links and the line between the nodes in FIG. 3 expresses the road link. FIG. 3 illustrates two plan creation zones 300A and 300B. The plan creation zone 300A is a zone from a plan creation zone start position 302A to a plan creation zone end position 304A, and the plan creation zone 300B is a zone from a plan creation zone start position 302B to a plan creation zone end position 304B.

Specifically, the navigation system decides the plan creation zone end position on the basis of a predetermined condition, going back the route from the destination side. The navigation system further goes back the route to decide the plan creation zone start position in accordance with the plan creation zone end position on the basis of a predetermined condition. Note that in the case where the route from the place of departure to the destination is long, the route is divided into a plurality of areas, one or a plurality of plan creation zones may be determined from the destination side for each of the divided areas. In addition, about the order of creating the plan for each divided area, the process may be performed in order from the area closer to the place of departure.

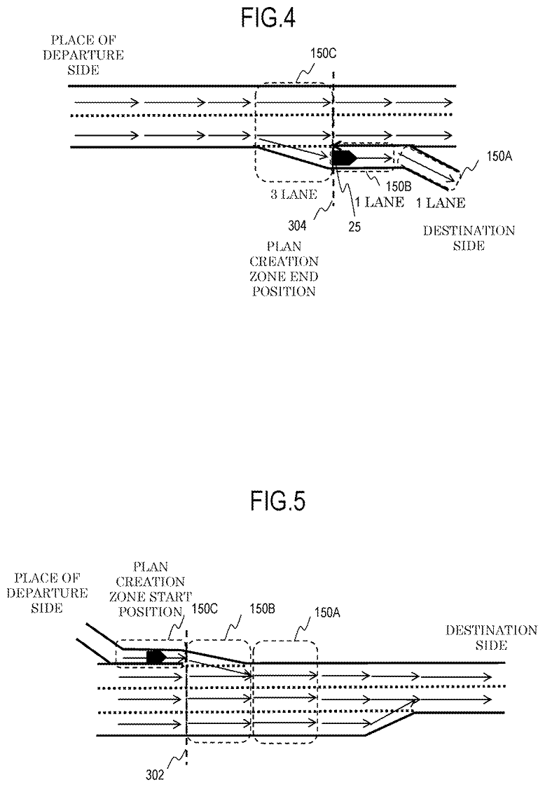

FIG. 4 illustrates an example of the condition for the plan creation zone end position. The plan creation zone end position corresponds to a particular lane link group. In the example in FIG. 4, the lane link group 150C corresponds to the plan creation zone end position 304. For example, the end position of the lane link group 150C corresponds to the plan creation zone end position 304.

The condition of the plan creation zone end position in this example is that the number of lanes in the lane link group increases as the lane link groups are traced along the route from the destination side. This means that the number of lanes decreases along the route and some lane selection is considered necessary.

In the example in FIG. 4, the number of lanes in the lane link group 150C is three and the number of lanes in the adjacent lane link group 150B on the destination side is one. In addition, the number of lanes in the lane link group 150A adjacent to the lane link group 150B on the destination side is one. In the lane link group 150C, the number of lanes increases and it is determined that the lane link group 150C corresponds to the plan creation zone end position 304.

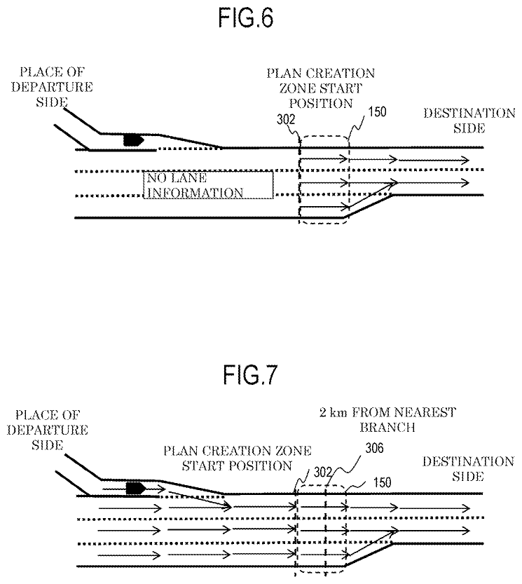

FIG. 5, FIG. 6, and FIG. 7 each illustrate an example of the condition of the plan creation zone start position. In the example in FIG. 5, the lane link group 150C corresponds to the plan creation zone start position 302. Specifically, the end position of the lane link group 150C corresponds to the plan creation zone start position 302. The condition of the plan creation zone start position in FIG. 5 is that the number of lanes in the lane link group changes from a numeral over one to one as the lane link groups are traced from the destination side along the route. This is because when the number of lanes in the lane link group is one, the lane selection is unnecessary.

In FIG. 5, the number of lanes in the lane link group 150C is one, and the number of lanes in the lane link group 150B that is adjacent thereto on the destination side is four. Moreover, the number of lanes in the lane link group 150A that is adjacent to the lane link group 150B on the destination side is three. The number of lanes changes from four in the lane link group 150B to one in the lane link group 150C.

In the example in FIG. 6, the lane link group 150 corresponds to the plan creation zone start position 302. Specifically, the start position of the lane link group 150 is the plan creation zone start position 302. The condition of the plan creation zone start position in FIG. 6 is that the lane link information is absent. In the absence of the lane link information, the lane recommendation degree cannot be calculated. In FIG. 6, there is no lane link information on the place of departure side in the lane link group 150. Therefore, the start position of the lane link group 150 is determined to be the plan creation zone start position 302.

In the example in FIG. 7, the lane link group 150 corresponds to the plan creation zone start position 302. Specifically, the start position of the lane link group 150 corresponds to the plan creation zone start position 302. The condition of the plan creation zone start position in FIG. 7 is that the distance from the nearest branch is over an upper limit (for example, 2 km). This is because if the distance to the branch is long, the difference in recommendation degree between the lanes is small. In FIG. 7, the position of the lane link group 150 is within the distance that satisfies the condition from the nearest branch. Therefore, the start position of the lane link group 150 is determined to be the plan creation zone start position 302. Note that the condition of the plan creation zone start position may use the nearest merger instead of the nearest branch, or may be that the distance from the nearest branch or merger is over the upper limit. One plan creation zone may include a plurality of branches or mergers.

The navigation system determines the position that satisfies any of the conditions shown in FIG. 5, FIG. 6, and FIG. 7 is the plan creation zone start position. The navigation system may refer to only a part of the conditions shown in FIG. 5, FIG. 6, and FIG. 7. As described above, the plan creation zone in the main lane group ranges from the merge lane to the branch lane, and includes the merge position and the branch position in the main lane group.

Next, an example of the method for calculating the lane recommendation degree is described. In the example below, the lane recommendation degree is determined for each lane link group. The recommendation degree of each lane in the lane link group is determined on the basis of the number of times of changing lanes necessary before the last branch in the plan creation zone, the distance to the nearest indispensable lane change, and the required passage time in this example.

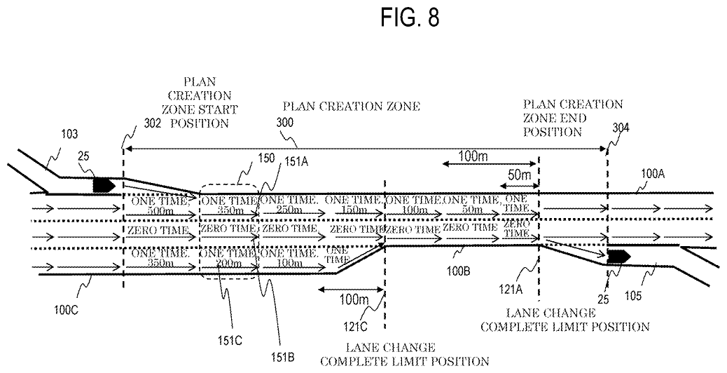

FIG. 8 is a diagram for describing the element (condition) that is referred to in the calculation of the recommendation degree. In FIG. 8, a pair of numerals near each lane link (expressed by an arrow) represents the number of times of changing lanes necessary before the branch at the plan creation zone end position and the distance to the nearest indispensable lane change. In FIG. 8, the plan creation zone 300 ranges from the plan creation zone start position 302 to the plan creation zone end position 304.

In the example in FIG. 8, the vehicle 25 enters the branch lane 105 from the main lane 100B before the plan creation zone end position 304. Therefore, in order to advance to the branch lane 105 at the plan creation zone end position 304, the vehicle 25 needs to travel in the main lane 100B. Thus, the number of times of changing lanes necessary in all the lane links in every lane link in the main lane 100B is zero, and as a result, the distance to the nearest indispensable lane change is not defined.

The number of times of the necessary lane change is one for each lane link in the main lanes 100A and 100C. This means the lane change from the current lane to the main lane 100B. In the nearest indispensable lane change in the main lane 100C, the vehicle 25 needs to move from the main lane 100C to main lane 100B before a lane change complete limit position 121C because the main lane 100C ends (the number of lanes decreases).

The lane change complete limit position is the position where the change to the adjacent lane needs to be completed. The lane change complete limit position is the position determined on the basis of the lane end point, the branch position, or the like in the case where the lane change to deal with the decrease in number of lanes or branch into the branch lane is necessary. The lane change complete limit position is determined on the basis of the map data and the recommendation route information.

The nearest indispensable lane change in the main lane 100A is the final branch in the plan creation zone, that is, the lane change to the main lane 100B to branch into the branch lane 105. The vehicle 25 needs to move from the main lane 100A to the main lane 100B before the lane change complete limit position 121A.

The distance to the nearest indispensable lane change in the lane link of the lane 100A is determined on the basis of the lane change complete limit position 121A. In addition, the distance to the nearest indispensable lane change in the lane link of the lane 100C is determined on the basis of the lane change complete limit position 121C. In the example in FIG. 8, the distance from the lane change complete limit position to the end point (head point) of the lane link is the distance to the nearest indispensable lane change of the lane link.

For example, the lane link group 150 in FIG. 8 is formed by a lane link 151A in the lane 100A, a lane link 151B in the lane 100B, and a lane link 151C in the lane 100C. The number of times of the necessary lane changes in the lane link 151A is one, and the distance to the lane change complete limit position 121A is 350 m. The number of times of the necessary lane changes in the lane link 151B is zero, and the distance to the nearest indispensable lane change is not defined. The number of times of the necessary lane changes in the lane link 151C is one, and the distance to the lane change complete limit position 121C is 200 m.

The navigation system can decide the information in each link in the plan creation zone on the basis of the map information that is registered in advance and the information about the route set between the place of departure and the destination that are designated by the user.

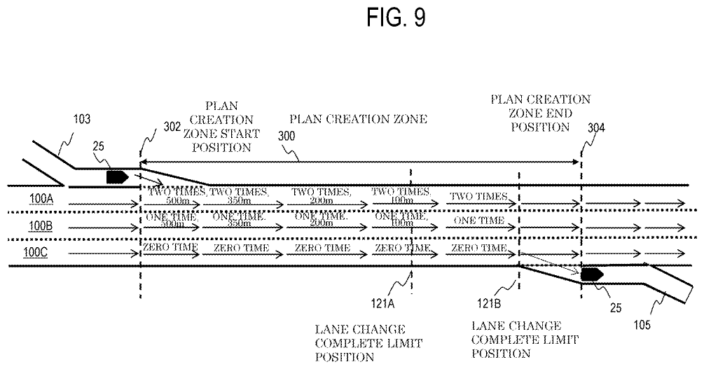

FIG. 9 illustrates another example for describing the elements that are referred in the calculation of the recommendation degree. The difference from the example in FIG. 8 is mainly described. In the plan creation zone 300, the main lanes 100A, 100B, and 100C that exist in parallel to each other in the main lane group extend from the plan creation zone start position 302 to the plan creation zone end position 304. The vehicle 25 goes to the branch lane 105 from the main lane 100C.

Therefore, the number of times of changing lanes in each lane link of the main lane 100A is two, the number of times of changing lanes in each lane link of the main lane 100B is one, and the number of times of changing lanes in each lane link of the main lane 100C is zero. The lane where the recommendation degree is the highest is the main lane 100C, and the lane where the recommendation degree is the lowest is the main lane 100A.

The lane change complete limit position 121A from the main lane 100A to the main lane 100B and the lane change complete limit position 121B from the main lane 100B to the main lane 100C are set. The distance between the main lane 100A and the main lane 100C is longer than the distance between the main lane 100B and the main lane 100C; therefore, the lane change complete limit position 121A is set before the lane change complete limit position 121B.

For example, the lane change complete limit position 121A for changing the lanes from the main lane 100A to the main lane 100B is set at the position going back toward the place of departure side from the lane change complete limit position 121B from the main lane 100B to the main lane 100C by the distance necessary for the lane change and the distance corresponding to the margin from the guidance implementation to the lane change start. The start position of the lane change start recommendation zone from the main lane 100B to the main lane 100C coincides with the lane change complete limit position from the main lane 100A to the main lane 100B.

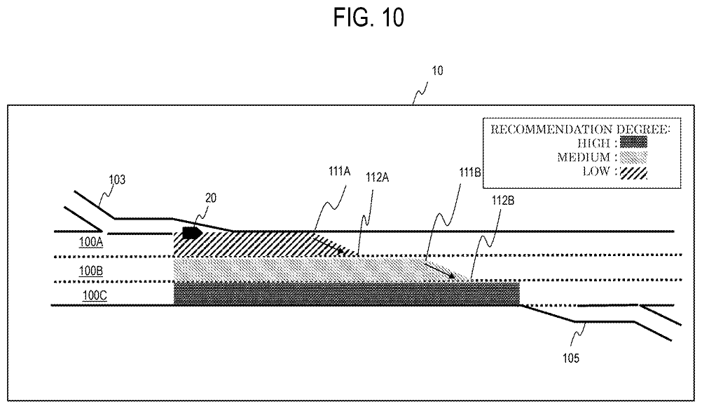

FIG. 10 illustrates the display image 10 by the navigation system that is used in FIG. 9. As described with reference to FIG. 1, the lane recommendation degree is illustrated with the patterns. The start position 111A and the end position 112A of the lane change start recommendation zone in the main lane 100A are each shown by an end point of the oblique line pattern. Similarly, a start position 111B and an end position 112B of the lane change start recommendation zone in the main lane 100B are each shown by an end point of the oblique line pattern.

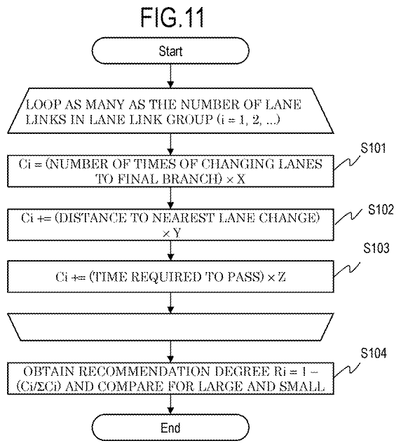

FIG. 11 is a flowchart of an example of calculating the recommendation degree. The navigation system decides the recommendation degree of each lane link in accordance with the flowchart in FIG. 11 for each lane link group. In the flowchart in FIG. 11, steps S101, S102, and S103 are performed for each lane link in the lane link group.

In step S101, the navigation system calculates the product of the number of times of changing lanes for moving from the lane in the lane link i selected from the current lane link group to the lane for the final branch in the plan creation zone, and a weight coefficient X, and adds the product to a variable Ci. In S102, the navigation system calculates the product of the distance from the lane link i to the nearest indispensable lane change and a weight coefficient Y, and adds the product to the variable Ci.

In step S103, the navigation system calculates the product of the required passage time in the lane link i and a weight coefficient Z, and adds the product to the variable Ci. The required passage time can be decided on the basis of the current average required passage time obtained from the traffic congestion information from an external system, and the average speed and the distance of the lane link defined in the map information. Through the above calculation, the calculation of the variable Ci in the lane link i ends.

In step S104, the navigation system decides the recommendation degree Ri of each lane link i in the lane link group in accordance with the following expression: Ri=1−(Ci/ΣCi). The weight coefficient X is decided so that the recommendation degree decreases as the number of times of changing the lanes is larger. The weight coefficient Y is decided so that the recommendation degree decreases as the distance to the nearest indispensable lane change is shorter. The weight coefficient Z is decided so that the recommendation degree decreases as the required passage time is longer.

The method for deciding the recommendation degree described above is just one example, and the navigation system may decide the lane recommendation degree by another method. For example, the navigation system may decide the lane recommendation degree on the basis of one or two elements among the above three elements. For example, the navigation system may refer to only the number of times of the necessary lane change and omit the required passage time. By deciding the recommendation degree of the lane link with the use of a part of or the entire elements, the proper lane recommendation degree can be obtained.

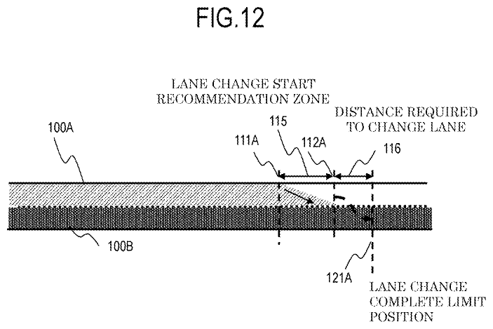

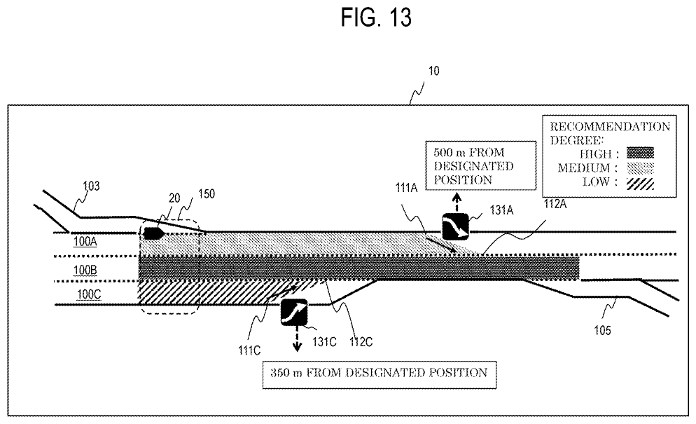

Next, the method for deciding the lane change start recommendation position (recommendation zone) is described. The lane change start recommendation position is decided on the basis of a predetermined condition. For example, the lane change start recommendation position is decided on the basis of the distance necessary for the lane change and the margin from the guidance of the lane change (with a sound to the driver, for example) to the actual lane change start. FIG. 12 is a diagram for describing the method for deciding the lane change start recommendation position. FIG. 12 illustrates a lane change start recommendation zone 115 in the lane change from the lane 100A to the lane 100B.

The lane change start recommendation zone 115 is the zone where the start of the lane change is recommended, and each position is the lane change start recommendation position. The navigation system decides the lane change start recommendation zone 115 from the lane change complete limit position 121A. The lane change complete limit position 121A is the position where the lane change of the vehicle 25 needs to be completed.

For example, the navigation system determines that the position with the distance necessary for the lane change from the lane change complete limit position 121A is the lane change start recommendation zone end position 112A. The navigation system determines that the position with a predetermined margin from the lane change start recommendation zone end position 112A after the lane change is guided and before the lane change actually starts is the lane change start recommendation zone start position 111A. The distance of the lane change start recommendation zone 115 coincides with the margin.

When the vehicle 25 has arrived at the lane change start recommendation zone start position 111A, the navigation system guides the driver to change lanes with a sound or an image, or instructs the automated driving system to change lanes. By showing the user the lane change start recommendation zone 115 in advance, the user can understand the lane change easily.

The calculation of the distance necessary for the lane change and the margin is optional and is not limited to a particular method. For example, the distance necessary for the lane change is determined on the basis of the vehicle speed, the lane width, and the like so that a sudden turn of the steering wheel will not occur. The calculation of the margin from when the guidance implementation of the lane change is carried out and to when the lane change is actually started can be determined on the basis of a predetermined calculation formula that is set in advance, and the average speed obtained from the speed limit of the lane and the traffic information, for example. The calculation formula that is set in advance takes into consideration the travel distances during the guidance implementation, checking the periphery, standing-by for the lane change, and the speed control.

The navigation system shows the lane structure of at least a part of a zone in the main lane group and the recommendation degree of at least a part of the lane links in the lane change plan image. Thus, the user can understand the lane change plan more easily. As described above, providing the lane structure, the lane recommendation degree, and the lane change start recommendation position about all the area and all the lanes from the start point to the end point of the plan creation zone are very helpful for the user. The navigation system may provide only the information about the lane recommendation degree without providing the information about the lane change recommendation position, for example.

In another example, only some lanes may be explicitly shown without providing the lane recommendation degree of all the lanes. For example, the navigation system may change the lane to show the recommendation degree in accordance with the lane where the vehicle travels. For example, the navigation system may selectively display the recommendation degrees of the lane where the vehicle currently travels and the lane adjacent thereto in the lane change plan image.

In another example, in the case where the current lane is the lane with the highest recommendation degree, the navigation system may provide the recommendation degree of only that lane. If the current lane is unknown, the navigation system provides the recommendation degrees of all the lanes. The navigation system may select a part of the plan creation zone and display the lane recommendation degree and the lane change start recommendation position.

In one example, the navigation system changes the range of the zone to display depending on whether the vehicle is currently automatically driven. Specifically, the display zone in the manual driving is shorter than the display zone during the automated driving. Thus, the amount of information to display in the manual driving is reduced so that the information is not provided too much to the driver who is currently driving.

Next, the provision of the additional information about the lane change plan in the plan creation zone is described. In the example to be described below, the navigation system shows the reason of the lane recommendation degree and/or the lane change recommendation position. Thus, the user can understand more about the lane change plan.

FIG. 13 illustrates the image example 10 that expresses the distance to the nearest indispensable lane change as the reason of the lane recommendation degree. An icon 131A is shown near the lane change start recommendation zone (defined by the positions 111A, 112A) of the main lane 100A. The lane change start recommendation zone corresponds to the nearest indispensable lane change position for all the lane links in the main lane 100A behind the icon 131A in the plan creation zone.

An icon 131C is shown near the lane change start recommendation zone (defined by the positions 111C, 112C) of the main lane 100C. The lane change start recommendation zone corresponds to the nearest indispensable lane change position for all the lane links in the main lane 100C behind the icon 131C in the plan creation zone.

It is assumed that, in FIG. 13, the own vehicle is specified as existing in the lane link group 150. When the icon 131A is selected by the user through the input device, the navigation system shows the distance from the lane link group 150 that is designated in advance to the nearest indispensable lane change position shown by the icon 131A. Similarly, when the icon 131C is selected, the navigation system shows the distance from the lane link group 150 to the nearest indispensable lane change position shown by the icon 131C.

In the example in FIG. 13, in the lane link group 150, the distance to the nearest indispensable lane change in the lane 100A is longer than the distance to the nearest indispensable lane change in the lane 100C. Therefore, in the viewpoint of the distance to the nearest indispensable lane change, the recommendation degree of the lane 100A is higher than that of the lane 100C.

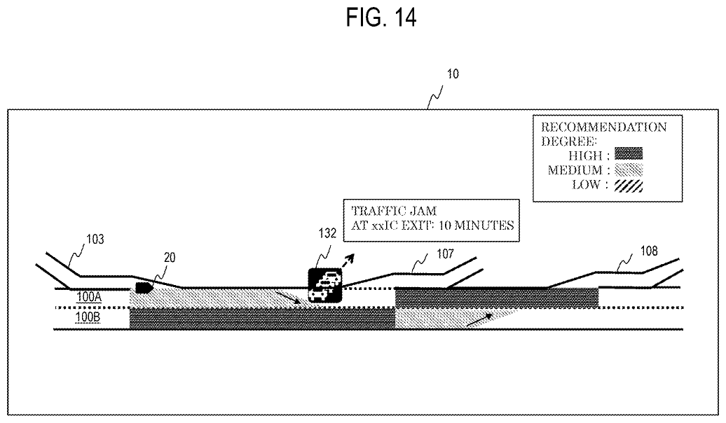

FIG. 14 illustrates the image example 10 that expresses the lane level traffic congestion information. In the image example 10 in FIG. 14, the vehicle enters the main lane 100A from the merge lane 103, passes the main lanes 100A and 100B, and goes to a branch lane 108 out of the main lane 100A. A branch lane 107 from the main lane 100A exists before the branch lane 108.

In the example in FIG. 14, an icon 132 is displayed overlapping the lane 100A. In this example, the icon 132 is displayed at a position where the traffic jam has occurred. The navigation system can acquire the traffic congestion information from the external system. When the user has selected the icon 132 through the input device, the navigation system shows the traffic congestion information at the position indicated by the icon 132.

In the example in FIG. 14, the traffic jam occurs at the main lane 100A and does not occur in the main lane 100C. Before the traffic jam occurrence position, the time required to pass the lane link in the main lane 100A is longer than the time required to pass the lane line in the main lane 100C. Therefore, the recommendation degree of the main lane 100C before the traffic jam occurrence position is higher than that of the main lane 100A.

From indicated in the image example 10 in FIG. 14, the user can understand that the reason why the lane change from the main lane 100A to the right main lane 100B is recommended though the branch lane 108 exists on the left side of the main lane 100A is because the traffic jam has occurred.

In another example, the navigation system may display the time required to pass every lane in one lane link group or a plurality of successive lane link groups that is designated by the user. For example, the navigation system receives the designation of the zone defined by the start lane link group and the end lane link group, and displays the time required to pass each lane in the designated zone or the designated lane. By referring to the time required to pass each lane, the user can know the reason of the recommendation degree of each lane.

The navigation system may display the number of times of lane changes or the risk of other vehicle's merging as other reasons. As described above, by showing the icon or the detailed information about the selected icon, the information can be provided in an aspect that the user can easily see. In another example, the navigation system may display the reason of the lane recommendation degree directly without using the icon. The navigation system may always display the reason of the lane recommendation degree or the icon to show the reason while the vehicle travels in the plan creation zone (zone where the lane change is planned).

The navigation system may display these only when a predetermined condition is satisfied. Thus, the user can recognize the necessary information while avoiding the display of the unnecessary information. For example, the navigation system may display the information on the condition that the final branch direction and the nearest lane change direction are not the same.

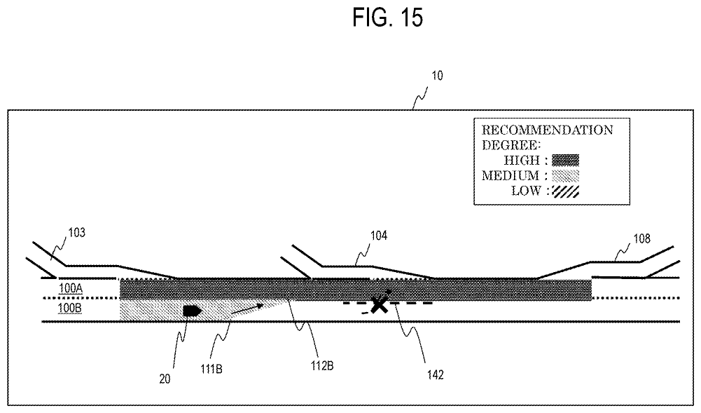

Next, an example of displaying the reason of the lane change recommendation position is described. The display image example in FIG. 15 expresses a lane change prohibition zone as the reason (condition) of the lane change recommendation position. In the example in FIG. 15, the vehicle enters the main lane 100A from the merge lane 103, and a current vehicle 20 that currently travels in the main lane 100B is shown. The vehicle then moves from the main lane 100B to the main lane 100A, and goes out to the branch lane 108. Between the branch lane 108 and the merge lane 103, there is a merge lane 104 that connects to the main lane 100A.

The image example 10 in FIG. 15 shows the lane change start recommendation zone that is defined by the positions 111B and 112B. In addition, as the reason of the lane change start recommendation zone, a lane change prohibition zone 142 existing ahead of the lane change start recommendation zone is displayed. In this example, the distance from the end point of the lane change prohibition zone 142 to the branch lane 100 is not enough for the lane change with a margin.

Therefore, the navigation system determines that the lane change needs to be performed before the lane change prohibition zone 142. The navigation system calculates the lane change start recommendation zone on the basis of the start position of the lane change prohibition zone 142. The distance necessary for the lane change and the lane change start recommendation zone may be calculated by a method that is the same as or similar to the method described with reference to FIG. 12.

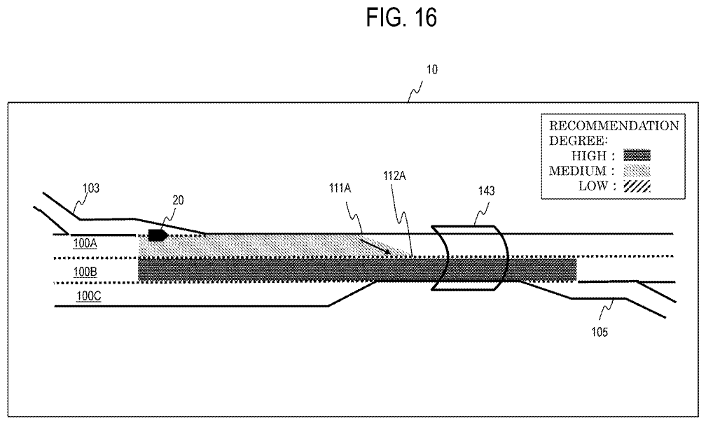

In the display image example 10 in FIG. 16, a tunnel is shown as the reason (condition) of the lane change recommendation position. Although the lane change is not prohibited in the tunnel, the lane change in the tunnel is less safe than the lane change outside the tunnel and therefore is not recommended. The navigation system decides the lane change recommendation position assuming that the lane change in the tunnel is not performed.

In the example in FIG. 16, the vehicle enters the main lane 100A from the merge lane 103, passes the main lanes 100A, 100B, and 100C, and then goes out to the branch lane 105 from the main lane 100B. The image example 10 in FIG. 16 shows the lane change start recommendation zone that is defined by the positions 111A and 112A. Furthermore, a tunnel 143 existing ahead of the lane change start recommendation zone is shown as the reason of the lane change start recommendation zone.

The distance from the exit of the tunnel 143 to the entrance of the branch lane 105 is insufficient for the lane change with a margin. Thus, the navigation system determines that the lane change is necessary before the tunnel 143. The navigation system calculates the lane change start recommendation zone on the basis of the start position of the tunnel 143. The distance necessary for the lane change and the lane change start recommendation zone may be calculated by a method that is the same as or similar to the method described with reference to FIG. 12.

For example, the navigation system may display an intersection as another reason of the lane change recommendation position. This is because the lane change is not recommended near the intersection. As described above, the lane change start recommendation position is decided so as to avoid an avoidance zone that is designated in advance, such as an in-tunnel zone, a lane change prohibition zone, and a predetermined range from the intersection. Thus, the lane change can be recommended more suitably.

While the vehicle travels in the plan creation zone (zone where the lane change is planned), the navigation system may always display the reason of the lane change recommendation position, or the navigation system may display the reason only when a predetermined condition is satisfied. Thus, the user can recognize easily the necessary information avoiding the display of the unnecessary information.

For example, if the lane change from the current lane is necessary, the reason may be displayed. In the example in FIG. 16, the navigation system does not display the tunnel 143 while the vehicle travels in the lane 100B and displays the tunnel 143 when the vehicle travels in another lane.

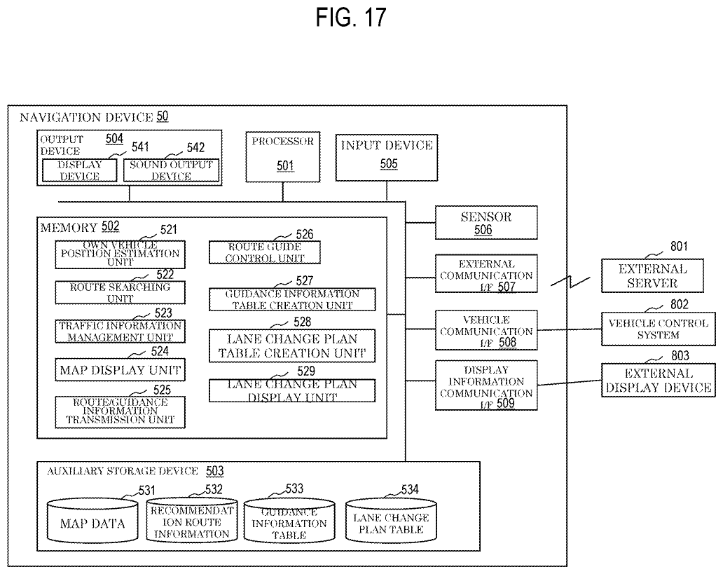

The structure and the process of the navigation system are described below. FIG. 17 schematically illustrates a structure example of a navigation device disposed in the vehicle as one example of the navigation system. A navigation device 50 includes a processor 501, a memory (main storage device) 502, an auxiliary storage device 503, an output device 504, an input device 505, a sensor 506, an external communication interface (I/F) 507, a vehicle communication I/F 508, and a display information communication I/F 509.

The input device 505 is a device that receives the input such as the user's instruction, and, for example, the input device 505 is a touch panel. The output device 504 includes a display device 541 and a sound output device 542. The display device 541 displays an image for map or route guidance, for example, for the user. The sound output device 542 outputs the sound for the route guidance, for example.

The memory 502 stores programs including command codes to be executed by the processor 501. A typical example of the memory 502 is a high-speed, volatile storage device like a DRAM (Dynamic Random Access Memory). In this example, the programs stored in the memory 502 include an own vehicle position estimation unit 521, a route searching unit 522, a traffic information management unit 523, a map display unit 524, a route/guidance information transmission unit 525, a route guide control unit 526, a guidance information table creation unit 527, a lane change plan table creation unit 528, and a lane change plan display unit 529.

The own vehicle position estimation unit 521 estimates the current position of the vehicle on the basis of the information from the sensor 506 (GPS sensor). The route searching unit 522 generates a recommendation route between the place of departure and the destination that are designated by the user, and stores recommendation route information 532 in the auxiliary storage device 503. The traffic information management unit 523 acquires the real-time traffic information from an external server 801 through the external communication I/F 507. The map display unit 524 causes the display device 541 to display the map including the recommendation route.

The route/guidance information transmission unit 525 transmits the information about the recommendation route to the vehicle control system 802 through the vehicle communication I/F. The route guide control unit 526 guides the driving by the user and/or the automated driving system following the recommendation route. The guidance information table creation unit 527 creates a guidance information table 533. The lane change plan table creation unit 528 creates a lane change plan table 534. The lane change plan display unit 529 causes the display device 541 to display an image expressing the lane change plan in the plan creation zone. Note that the data of the image to be displayed on the display device 541 may be transmitted through the display information communication I/F 509 to an external display device 803 such as an HUD (Head-Up Display) or a meter.

In the memory 502, at least a part of the programs and data stored in the auxiliary storage device 503 may be copied as necessary when the processor 501 executes various processes, and other programs or reference data thereof may be stored. In addition, the memory 502 may store the result of the process executed by the processor 501.

The auxiliary storage device 503 stores the information to which to be referred for the processor 501 to execute various processes on the basis of the programs. The auxiliary storage device 503 in this example stores map data 531, the recommendation route information 532, the guidance information table 533, and the lane change plan table 534. One typical example of the auxiliary storage device 503 is a high-capacity, nonvolatile storage device such as an HDD (Hard Disk Drive) or a flash memory. Each of the memory 502, the auxiliary storage device 503, and a combination thereof is a storage device including a non-transitory storage medium.

The processor 501 executes various processes in accordance with the command codes of the programs stored in the memory 502. The processor 501 operates as various function units by executing the programs. The processor 501 can be formed of a single processing unit or a plurality of processing units, and include one or more calculating units or a plurality of processing cores. The processor 501 may be mounted as one or more central processing units, microprocessors, microcomputers, microcontrollers, digital signal processors, state machines, logic circuits, graphic processing units, chip-on systems, and/or arbitrary devices that operate signals on the basis of a control instruction.

As described above, by the processor 501 executes the programs, the various processes in the navigation device 50 are performed. Therefore, in the following description, the process to be performed by the program or the function unit is the process to be performed by the processor 501 or the navigation device 50.

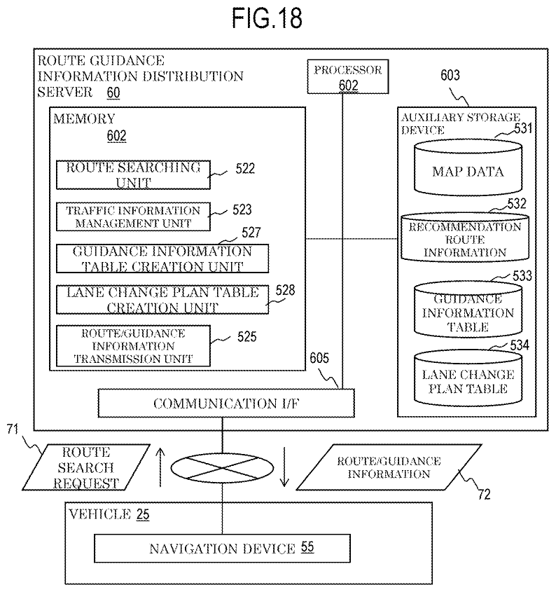

A part of the functions of the navigation according to the present disclosure may be mounted on a server included in the navigation system instead of the navigation device. FIG. 18 illustrates a structure example of a route guidance information distribution server 60 including a part of the navigation functions according to the present disclosure. The route guidance information distribution server 60 includes a processor 601, a memory (main storage device) 602, an auxiliary storage device 603, and a communication I/F 605.

The memory 602 stores the route searching unit 522, the traffic information management unit 523, the route/guidance information transmission unit 525, the guidance information table creation unit 527, and the lane change plan table creation unit 528. Other programs illustrated in FIG. 17 are stored in a navigation device 55. The function of each program is similar to that in the program illustrated in FIG. 17. The auxiliary storage device 603 stores the map data 531, the recommendation route information 532, the guidance information table 533, and the lane change plan table 534 in a manner similar to the navigation device 50 in FIG. 17.

The route guidance information distribution server 60 having received a route search request 71 from the navigation device 55 in the vehicle 25 through the network returns route/guidance information 72 including the recommendation route information, the guidance information table, the lane change plan table, and the like to the navigation device 55 through the network.

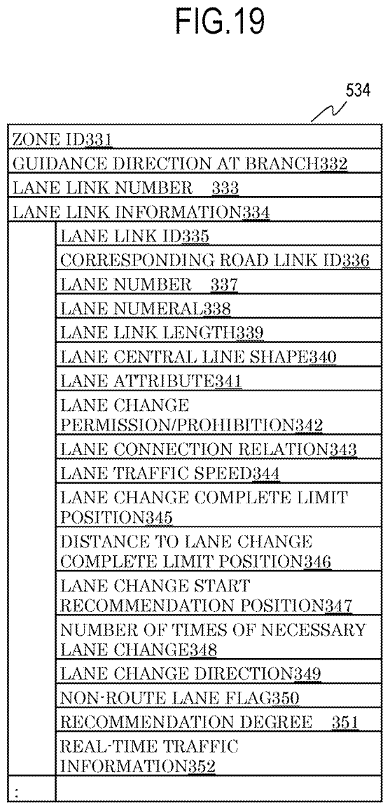

FIG. 19 illustrates a structure example of the lane change plan table 534. The lane change plan table 534 is created for each plan creation zone. FIG. 19 illustrates only the items of the lane change plan table 534. A zone ID 331 expresses the ID that identifies the corresponding plan creation zone. A guidance direction 332 at the branch expresses the direction of the final branch in the plan creation zone. The guidance direction 332 at the branch is referred to for deciding the display of the reason of the lane recommendation degree or the lane change start recommendation position. A lane link number 333 represents the total number of lane links in the plan creation zone.

Lane link information 334 expresses the information about each link in the plan creation zone, and includes a plurality of items that is described below. A lane link ID 335 represents the ID that identifies the lane link. A corresponding road link ID 336 represents the ID Of one or a plurality of road links where the lane links overlap. By the road link ID 336, the lane link for the position on the route can be specified, for example. The road link is referred to, for example, when the recommendation route from the place of the departure to the destination is decided. The road link at each position in the route is only one. One lane link may overlap one or more road links.

A lane number 337 represents the number of lanes in the lane link group to which the lane link belongs. A lane numeral 338 represents the numeral of the lane including the lane link. The lane number 337 and the lane numeral 338 can specify the positional relation between the lane link and another lane link in the lane link group, for example.

A lane link length 339 represents the length of the lane link. A lane central shape 340 represents the shape of the center of the lane link and may be linear or curved. The lane link length 339 and the lane central shape 340 are used to calculate the distance to the lane change complete limit position, for example.

A lane attribute 341 represents the attribute of the lane link, and for example represents that the lane link exists in the tunnel and the lane link is the final lane in the lane. A lane change permission/prohibition 342 represents whether the lane change is possible in the lane link. These pieces of information are used to decide the lane recommendation degree or the lane change start recommendation position, or to show the reason thereof.

A lane connection relation 343 expresses the ID of the lane link connected before and after the lane link. The lane connection relation 343 is used to calculate the distance to the lane change complete limit position, for example. Lane traffic speed 344 represents the expected speed (predetermined value) in the lane link and is used to calculate the distance necessary to change lanes, for example.

A lane change complete limit position 345 represents the distance from a start point of the lane link to the lane change complete limit position 345 for the lane link (lane link group) including (overlapping) the lane change complete limit position. The lane change complete limit position 345 represents the initial value for the nonrelevant lane link (for example, NULL).

A distance 346 to the lane change complete limit position represents the distance from the nearest lane change complete limit position to the lane link in which the lane change complete limit position 345 is not set. The distance 346 to the lane change complete limit position represents the initial value (for example, NULL) for the nonrelevant lane link. The lane change complete limit position 345 and the distance 346 to the lane change complete limit position are used to calculate the distance to the lane change complete limit position, for example.

A lane change start recommendation position 347 represents the lane change start recommendation zone start position or the lane change start recommendation zone end position included in (overlapping) the lane link. For example, the lane change start recommendation position 347 represents the distance from the start point or the end point of the lane link to the lane change start recommendation zone start position or the lane change start recommendation zone end position. In the case where the lane link does not overlap any position, the lane change start recommendation position 347 represents the initial value (for example, NULL). The lane change start recommendation position 347 is used to display the lane change start recommendation position, for example.

A number of times of necessary lane change 348 represents the number of times of the necessary lane changes from the lane link to the lane in the final branch. The number of times of necessary lane change 348 is used to decide the lane recommendation degree, for example. A lane change direction 349 represents the nearest indispensable lane change direction from the lane link. The lane change direction 349 is referred for the lane change guidance (for example, an arrow is displayed).

A non-route lane flag 350 represents whether the lane link is the lane link in the recommendation route from the place of departure to the destination or the lane link outside the recommendation route. Thus, the information about the lane link close to the recommendation route from the place of departure to the destination can be maintained and for example is used to display the non-route lane. A recommendation degree 351 represents the recommendation degree of the lane link. The recommendation degree 351 is used to display the lane recommendation degree, for example. Real-time traffic information 352 represents the traffic information in real time about the lane link. The real-time traffic information 352 is referred to when the reason of the lane recommendation degree or the lane change start recommendation position is specified, for example.

In the lane change plan table 534, the items 335 to 344 are registered to the map data 531 in advance. The real-time traffic information 352 is acquired from the external system. The other items are calculated by the navigation system and decided.

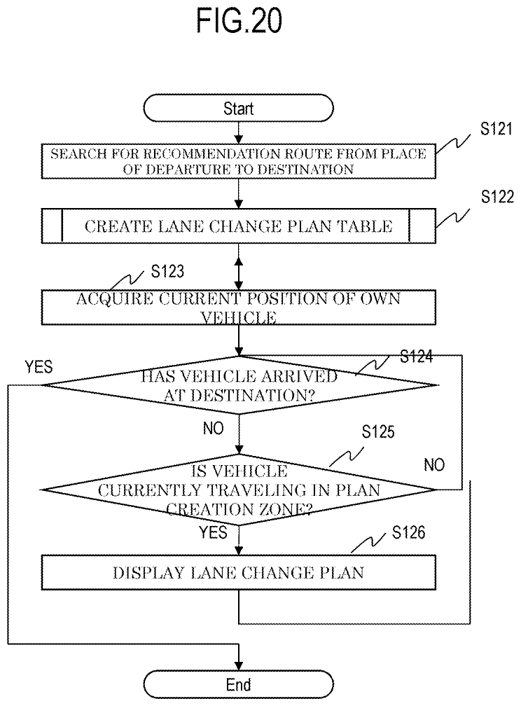

FIG. 20 illustrates an example of the procedure of the overall process for providing the navigation information according to the present embodiment. The route searching unit 522 searches the map data 531 for the recommendation route to the destination from the place of departure designated by the user (S121). The route searching unit 522 stores the information 532 about the created recommendation route in the auxiliary storage device 503. The guidance information table creation unit 527 creates the guidance information table 533 with reference to the recommendation route information 532.

The lane change plan table creation unit 528 creates the lane change plan table 534 on the basis of the information about the recommendation route and stores the created table in the auxiliary storage device 503 (S122). The creation of the lane change plan table 534 is described below in detail. Note that the lane change plan table 534 may be created again when the real-time traffic information 352 is updated.

The map display unit 524 causes the display device 541 to display the map acquired from the map data 531 so that the current position of the own vehicle is displayed on the basis of the recommendation route information 532 and the position of the own vehicle on the route. The route guide control unit 526 guides the own vehicle along the route on the basis of the recommendation route information 532, the guidance information table 533, and the position of the own vehicle on the route. For example, the route guide control unit 526 displays a guide image on the map displayed on the display device 541 or instructs the automate driving system the travel route or the lane. The position of the own vehicle is estimated on the basis of the information about GPS (Global Positioning System) by the own vehicle position estimation unit 521.

The route guide control unit 526 acquires the position of the own vehicle on the recommendation route from the own vehicle position estimation unit 521 (S123) and determines whether the own vehicle has arrived at the destination on the basis of the own vehicle position (S124). If the own vehicle has arrived at the destination (S123: YES), the process in this procedure ends. If the own vehicle has not arrived at the destination (S123: NO), the route guide control unit 526 determines whether the own vehicle is currently driving in the plan creation zone (S124). For example, in the case where the current road link is included in any one of the lane change plan table 534, the route guide control unit 526 determines that the own vehicle is currently traveling in the plan creation zone.

If the own vehicle is not driving in the plan creation zone (S124: NO), the process in this procedure ends. If the own vehicle is driving in the plan creation zone (S124: YES), the lane change plan display unit 529 instructed by the route guide control unit 526 displays the lane change plan in the plan creation zone as illustrated in FIG. 1, FIG. 10, and FIGS. 13 to 16 in accordance with the instruction from the route guide control unit 526 (S125).

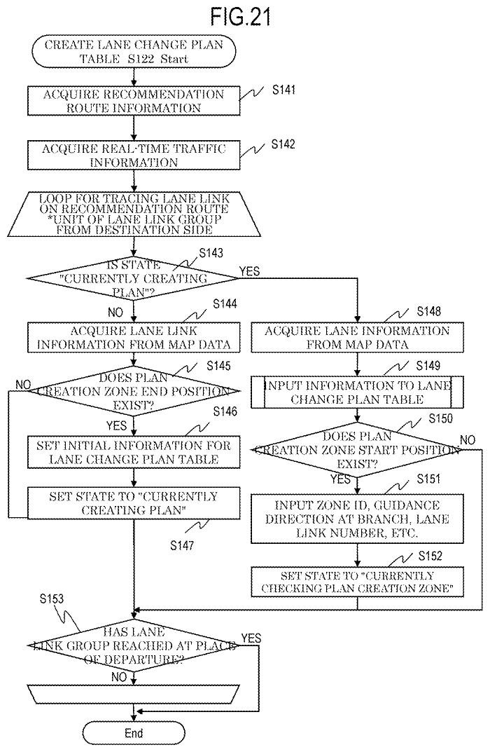

Next, the creation of the lane change plan table is described in detail. FIG. 21 is a flowchart illustrating an example of the creation of the lane change plan table S122. The lane change plan table creation unit 528 acquires the recommendation route information 532 from the place of departure to the destination (S141). The lane change plan table creation unit 528 acquires the real-time traffic information from the external server 801 through the traffic information management unit 523 and the external communication I/F 507 (S142). The lane change plan table creation unit 528 selects the lane link group sequentially from the destination and performs steps S143 to S153.

If the lane change plan table creation unit 528 sees the state variable and the state variable does not indicate “creating plan” (S143: NO), the lane change plan table creation unit 528 acquires from the map data 531, the information about the lane forming the selected (current) link group and the information about the lane link forming the previous lane link group (adjacent to the departure side) (S144).

The lane change plan table creation unit 528 determines whether the plan creation zone end position related to the current lane link group exists (S145). Specifically, as described with reference to FIG. 4, the lane change plan table creation unit 528 compares the number of lanes in the current lane link group and the number of lanes in the previous lane link group.

If the number of lanes in the previous lane link group is more than the number of lanes in the current lane link group, the lane change plan table creation unit 528 determines that there is the plan creation zone end position related to the current lane link group. For example, the end point of the previous lane link group is determined to be the plan creation zone end position.

If there is the plan creation zone end position related to the current lane link group (S145: YES), the lane change plan table creation unit 528 creates the lane change plan table 534 for the plan creation zone and sets the initial information (S146). The lane change plan table creation unit 528 further sets the state variable to “currently creating plan” (S147).

After that, the lane change plan table creation unit 528 determines whether the current lane link group has reached the place of departure of the recommendation route (S153). If the current lane link group includes the place of departure (S153: YES), this process ends. If the current lane link group does not include the place of departure (S153: NO), the lane change plan table creation unit 528 selects the next (previous on the recommendation route) lane link group and returns to step S143.

If the plan creation zone end position related to the current lane link group does not exist in step S145 (S145: NO), specifically, if the number of lanes in the previous lane link group is less than or equal to the number of lanes in the current lane link group, steps S146 and S147 are skipped.

If the state variable expresses “currently creating plan” in step S143 (S143: YES), the lane change plan table creation unit 528 acquires from the map data 531, the information about the lane forming the current lane link group and the information about the lane forming the previous (adjacent to the start place side) lane link group (S148). The lane change plan table creation unit 528 inputs the information about the lane link forming the current lane link group to the lane change plan table 534 (S149). The details of S149 in which the lane link information is input to the lane change plan table 534 are described below.

The lane change plan table creation unit 528 determines whether the plan creation zone start position about the current link group exists (S150). For example, if any of the conditions described with reference to FIG. 5, FIG. 6, and FIG. 7 is satisfied, it is determined that the plan creation zone start position exists. As described below, just a part of the conditions may be referred to.

As described above, if the number of lanes in the previous lane link group is one (FIG. 5), there is no information about the previous lane link group (FIG. 6), or the current lane link group includes a position with a predetermine distance from the nearest branch (FIG. 7), it is determined that the plan creation zone start position exists. The information about the nearest branch can be acquired from the map data 531.

If it is determined that the plan creation zone start position related to the current lane link group exists (S150: YES), the lane change plan table creation unit 528 inputs the values such as the zone ID 331, the guidance direction 332 at the branch, and the lane link number 333 to the lane change plan table 534 (S151). In addition, the lane change plan table creation unit 528 changes the value of the state variable to “currently checking the plan creation zone” (S152). The value of the state variable is one example and may be determined arbitrarily.

After step S152, the lane change plan table creation unit 528 advances to step S153. If it is determined that the plan creation zone start position related to the current lane link group does not exist (S150: NO), the lane change plan table creation unit 528 skips steps S151 and S152, and advances to step S153.

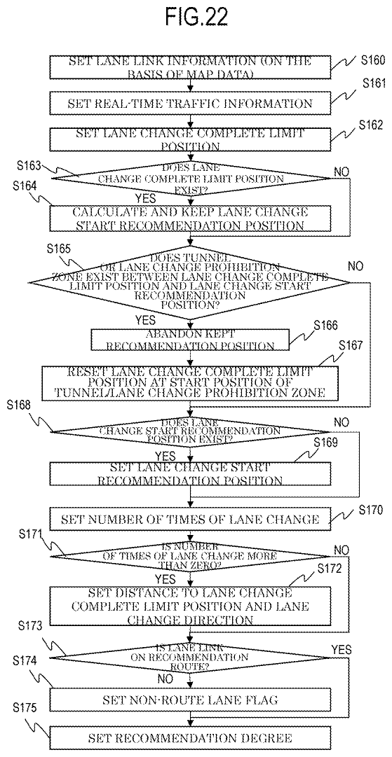

Next, the details of S149 in which the lane link information is input to the lane change plan table 534 about one lane link are described. FIG. 22 is a flowchart illustrating an example of a process in which the lane link information is input to the lane change plan table 534 about one lane link.

The lane change plan table creation unit 528 sets the information of the current lane link on the basis of the map data 531 in the lane change plan table 534 (S160). For example, the information in the items 335 to 344 is on the basis of the map data 531. The lane change plan table creation unit 528 acquires the real-time traffic information from the external server 801 and sets the information in the lane change plan table 534 (S161).

If the lane link includes (overlaps) the lane change complete limit position, the lane change plan table creation unit 528 sets the value in the lane change complete limit position 345 of the lane link in the lane change plan table 534 (S162). The lane change complete limit position is decided on the basis of the map data 531 and the recommendation route information 532. For example, the lane change complete limit position is decided on the basis of the distance necessary for the lane change and the margin from the guidance to the lane change start.

If the lane link includes the lane change complete limit position (S163: YES), the lane change plan table creation unit 528 calculates the two lane change start recommendation positions that define the lane change start recommendation zone and keeps the position (S164). Specifically, as described with reference to FIG. 12, the lane change plan table creation unit 528 calculates the two lane change start recommendation positions that define the lane change start recommendation zone on the basis of the lane change complete limit position, the distance necessary for the lane change, and the margin from the guidance to the lane change start.

Next, the lane change plan table creation unit 528 determines whether the tunnel or the lane change prohibition zone exists between the lane change complete limit position and the lane change start recommendation position with reference to the map data 531 (S165). If the tunnel or the lane change prohibition zone exists (S165: YES), the lane change plan table creation unit 528 abandons the kept lane change start recommendation position (S166).

Furthermore, the lane change plan table creation unit 528 resets the lane change complete limit position at the start position of the tunnel or the lane change prohibition zone, and keeps the position (S167). If the reset position does not overlap the current lane link, the lane change complete limit position 345 of the current lane in the lane change plan table 534 is changed to the initial value (for example, NULL). The lane change plan table creation unit 528

If the tunnel or the lane change prohibition zone does not exist (S165: NO), steps S166 and S167 are skipped. Next, the lane change plan table creation unit 528 determines whether the lane change start recommendation position exists on the lane link (S168). If the lane change complete limit position is reset, the lane change plan table creation unit 528 calculates the two lane change start recommendation positions as described above and determines whether any lane change start recommendation position exists on the lane link.

If the lane change start recommendation position exists on the lane link (S168: YES), the value expressing the lane change start recommendation position is set at the lane change start recommendation position 347 of the lane link (S169). If the lane change start recommendation position does not exist on the lane link (S168: NO), step S169 is skipped.

Next, the lane change plan table creation unit 528 sets the value in the number of times of necessary lane change 348 (S170). If the value of the number of times of necessary lane change is more than zero (S171: YES), the lane change plan table creation unit 528 sets the value in the distance 346 to the lane change complete limit position and the lane change direction 349 (S172). If the lane link overlaps the lane change limit complete position, the distance 346 to the lane change complete limit position remains to be the initial value (for example, NULL). If the value of the number of times of necessary lane change is zero (S171: NO), step S172 is skipped.

Next, the lane change plan table creation unit 528 determines whether the lane link exists on the recommendation route (S173). If the lane link is out of the recommendation route (S173: NO), the lane change plan table creation unit 528 sets the value in the non-route lane flag 350 (S174). If the lane link is on the recommendation route (S173: YES), step S174 is skipped. Next, the lane change plan table creation unit 528 calculates the recommendation degree of the lane link as described above and sets it as the recommendation degree 351.

Note that the present invention is not limited to the examples described above and may include various modifications. For example, the examples described above are to make it easier to understand the present invention, and are not limited to the structure including all the components that have been described. A part of the structure of one example may be replaced by the structure of another example, and a structure of one example may be added to a structure of another example. A part of a structure in each example may be added to, deleted from, or replaced by another structure.

Each structure, function, processing unit, etc. described above may be achieved by hardware formed of an integrated circuit entirely or partially. Each structure, function, etc. described above may be achieved by software in a manner that a processor construes and executes a program that achieves the corresponding function. The information about the program, table, file, and the like that achieve each function can be placed in a recording device such as a memory, a hard disk, or an SSD (Solid State Drive), or a recording medium such as an IC card or an SD card.

The control line and the information line that are considered necessary in the description are shown, and all the control lines and information lines in the product are not necessarily shown. It is possible to consider that substantially the entire structures are connected to each other in fact.

### REFERENCE SIGNS LIST

10 Display image
20 Vehicle image
25 Vehicle
50, 55 Navigation device
60 Route guidance information distribution server
100 Branch lane
100A, 100B, 100C Main lane
103, 104 Merge lane
105, 107, 108 Branch lane
111A, 111B, 111C Lane change start recommendation zone start position
112A, 112B, 112C Lane change start recommendation zone end position
115 Lane change start recommendation zone
121A, 121B, 121C Lane change complete limit position
142 Lane change prohibition zone
143 Tunnel
150 Lane link group
151 Lane link
201 Place of departure
203 Destination
300 Plan creation zone
302 Plan creation zone start position
304 Plan creation zone end position
501 Processor
502 Memory
503 Auxiliary storage device
504 Output device
505 Input device
506 Sensor
521 Own vehicle position estimation unit
522 Route searching unit
523 Traffic information management unit
524 Map display unit
525 Route/guidance information transmission unit
526 Route guide control unit
527 Guidance information table creation unit
528 Lane change plan table creation unit
529 Lane change plan display unit
531 Map data
532 Recommendation route information
533 Guidance information table
534 Lane change plan table
541 Display device
542 Sound output device
601 Processor
602 Memory
603 Auxiliary storage device
801 External server
802 Vehicle control system
803 External display device

1. A navigation system for a vehicle, comprising:
one or more processors; and
one or more storage devices storing programs to be executed by the one or more processors, wherein
the one or more processors decide a lane change plan creation zone including a main lane group including a plurality of main lanes that is parallel to each other in a route between a place of departure and a destination, and a recommendation degree of each of a plurality of lane links included in the main lane group, and
the one or more processors generate a lane change plan on the basis of the lane change plan creation zone and the recommendation degree.

2. The navigation system according to claim 1, wherein the main lane group in the lane change plan creation zone has reached a branch lane from a merge lane that merges into the main lane group.

3. The navigation system according to claim 1, wherein
the one or more processors calculate the recommendation degree of the lane links of all the lanes in the main lane group, and
the lane change plan indicates the recommendation degree of the lane links of all the lanes.

4. The navigation system according to claim 1, wherein the recommendation degree of the lane link is calculated on the basis of at least one of the number of times of changing lanes necessary to enter the branch lane from the lane link, a distance to the nearest indispensable lane change in the lane including the lane link, and a time required to pass the lane link.

5. The navigation system according to claim 1, further comprising a lane change plan display unit and a display device, wherein the lane change plan display unit outputs a lane change plan image on the basis of the lane change plan to the display device.

6. The navigation system according to claim 5, wherein the lane change plan image illustrates information about an element referred to when the recommendation degree of the lane link is calculated.

7. The navigation system according to claim 5, wherein
the one or more processors decide a lane change start recommendation position in the main lane group, and
the lane change plan image illustrates the lane change start recommendation position.

8. The navigation system according to claim 7, wherein
the one or more processors decide the lane change start recommendation position on the basis of a predetermined condition, and
the lane change plan image illustrates a condition on the basis of the reason on which the lane change start recommendation position is decided.

9. The navigation system according to claim 7, wherein the one or more processors decide the lane change start recommendation position so as to avoid an avoidance zone where a predetermined condition is satisfied.

10. The navigation system according to claim 5, wherein
the one or more processors generate a first lane change plan image including an icon and outputs the first lane change plan image to the display device, and
in response to a user's selection of the icon, the one or more processors generate a second lane change plan image illustrates information about an item referred to when the recommendation degree of the lane link is calculated and output the second lane change plan image to the display device.

11. The navigation system according to claim 1, wherein
the one or more processors receive a route search request from a device provided to the vehicle, and
in response to the route search request, the one or more processors transmit the lane change plan to the device provided to the vehicle through a network.

12. A method for generating a lane change plan for navigation by a navigation system for a vehicle, wherein
the navigation system decides a lane change plan creation zone including a main lane group including a plurality of main lanes that is parallel to each other in a route between a place of departure and a destination,
the navigation system decides a recommendation degree of each of a plurality of lane links included in the main lane group, and
the navigation system generates a lane change plan on the basis of the lane change plan creation zone and the recommendation degree.

13. A program for causing a navigation system for a vehicle to perform a process, the process including:
deciding a lane change plan creation zone including a main lane group including a plurality of main lanes that is parallel to each other in a route between a place of departure and a destination,
deciding a recommendation degree of each of a plurality of lane links included in the main lane group, and
generating a lane change plan on the basis of the lane change plan creation zone and the recommendation degree.
